(19) United States
(12) Patent Application Publication
(10) Pub. No.: US 2023/0362367 A1
(43) Pub. Date: Nov. 9, 2023

(54) SYSTEM AND METHOD FOR TRAINING ARTIFICIAL INTELLIGENCE MODELS FOR IN-LOOP FILTERS

(71) Applicant: SAMSUNG ELECTRONICS CO., LTD., SUWON-SI (KR)

(72) Inventors: Anubhav SINGH, Bengaluru (IN); Aviral AGRAWAL, Bengaluru (IN); Raj Narayana GADDE, Bengaluru (IN); H Keerthan BHAT, Bengaluru (IN); Yinji PIAO, Suwon-si (KR); Minwoo PARK, Suwon-si (KR); Kwangpyo CHOI, Suwon-si (KR)

(21) Appl. No.: 18/333,067

(22) Filed: Jun. 12, 2023

Related U.S. Application Data
(63) Continuation of application No. PCT/KR2023/002883, filed on Mar. 2, 2023.

(30) Foreign Application Priority Data
Mar. 3, 2022 (IN) 202241011598
Feb. 23, 2023 (IN) 202241011598

(51) Int. Cl. H04N 19/119; H04N 19/117; H04N 19/80; H04N 19/42; H04N 19/176

(52) U.S. Cl. CPC H04N 19/119; H04N 19/117; H04N 19/80; H04N 19/42; H04N 19/176

(57) ABSTRACT

An example method for training AI models for in-loop filters includes generating a training dataset by passing a video through a codec pipeline, extracting one or more predefined block features from the training dataset, creating a plurality of clusters based on the extracted one or more predefined block features from the training dataset, dividing the plurality of clusters into a sub-plurality of clusters based on the extracted one or more predefined block features and an intra-cluster variation threshold, and supplying the sub-plurality of clusters separately into a plurality of AI models based on the extracted one or more predefined block features.

### CROSS-REFERENCE TO RELATED APPLICATIONS

This application is a continuation of International Application No. PCT/KR2023/002883, designating the United States, filed Mar. 2, 2023, in the Korean Intellectual Property Receiving Office and claiming priority to Indian Provisional Patent Application No. 202241011598, filed Mar. 3, 2022 in the Indian Patent Office and to Indian Complete Patent Application No. 202241011598, filed Feb. 23, 2023 in the Indian Patent Office. The disclosures of each of these applications are incorporated by reference herein in their entireties.

### BACKGROUND

### Field

The disclosure relates to image processing including, for example, a system and method for training Artificial Intelligence (AI) models for in-loop filters for video compression.

### Description of Related Art

Codecs are compression technologies used to compress and decompress a signal or a data steam. The signal or the data stream may be associated with images, audios, videos, and the like. Further, the codecs include two components i.e., an encoder to compress and a decoder to decompress the signal or the data stream. With advancements in technology, there has been an increase in the use of Artificial Intelligence (AI)-based in loop filters to improve the quality of multimedia, such as images and videos, after the codec has performed its operation.

Conventionally, there are multiple solutions which apply AI-based in-loop filters in codecs. In conventional solutions, model selection is performed using a set of approaches, such as slice types-based approaches, quantization parameter-based approaches, and the like. However, a problem with conventional solutions of applying the AI based in-loop filters in codecs is the use of signaling in a bit stream and the use of multiple models to cover multiple codec parameter variations, such as slice type, quantization parameter, and the like. Conventional solutions are required to perform a model selection operation using the set of approaches, which increases complexity and memory requirement.

FIG. 1A is a block diagram 100 depicting a process of performing an in-loop filtering using codec parameters, as per an existing technique. At step 102, an in-loop filter model is selected for video block-1 104 from the multiple models 106. As depicted, the multiple models may be model 1, model 2, model n. The selected in-loop filter model is then applied to encoded video block 1 104. On applying the selected in loop filter model to the video block 1-104, a parameter-1 108 is obtained. The parameter-1 108 is the model index of the in-loop filter model which is used based on the error pattern and other low-lying features of the video block-1 104. At step 110, error pattern analysis and model selection operation are performed for obtaining parameter-2 112 which specifies the model selected for further post processing of the block based on above features. These parameters i.e., parameter 1 108 and parameter-2 112 are then signaled to the decoder, as bit streams. The decoder uses the parameters signaled in the bitstream to create a decoded video block-2 114. The video block-2 114 utilizes the signaled parameters-1 and-2 for video codec. The parameter 1 108 is utilized for in-loop filtering and parameter-2 112 is utilized for error pattern correction. Thus, the conventional approach requires the codec to signal codec parameter in the bit stream specific to the in-loop filtering. The use of parameter signaling in the bit stream requires codec specification changes and results in lesser gains.

FIG. 1B is a block diagram 116 depicting multiple codec parameter variations, as per an existing technique. As depicted, the slice type 118 may be I slice 120, B slice 122, and the like. Further, the Quantization Parameter (QP) 124 may be 0, 1 . . . up to a max quantization parameter. Thus, there can be different models for each combination of the multiple codec parameter variations. Table 1 shows an example scenario related to a model for each combination of a codec parameter 1 i.e., the slice type, and a codec parameter 2 i.e., the QP.

TABLE 1

| Codec parameter 1 | Codec parameter 2 | Model index |
|---|---|---|
| I Slice | QP 0-10 | Model 1 |
| I Slice | QP 10-20 | Model 2 |
| I Slice | QP 20-30 | Model 3 |
| I Slice | QP 30-40 | Model 4 |
| I Slice | QP 40-50 | Model 5 |
| B Slice | QP 0-10 | Model 6 |
| B slice | QP 10-20 | Model 7 |
| B Slice | QP 20-30 | Model 8 |
| B Slice | QP 30-40 | Model 9 |
| . . . | . . . | Model M |

Thus, the conventional solution requires different models for each combination of the multiple codec parameter variations which increases complexity and memory requirement of the system.

Therefore, there is a need for a mechanism to overcome the above identified issues and for training AI models for in-loop filters to perform in-loop filtering in a video codec and remove compression artifacts.

### SUMMARY

This summary is provided to introduce a selection of concepts in a simplified format that are further described in the detailed description. This summary is not intended to identify key or essential concepts of the disclosure, nor is it intended for determining the scope of the disclosure.

According to an embodiment of the present disclosure, a method for training Artificial Intelligence (AI) models for In-loop filters includes generating a training dataset by passing a video through a codec pipeline, extracting one or more predefined block features from the training dataset, creating a plurality of clusters based on the extracted one or more predefined block features from the training dataset, dividing the plurality of clusters into a sub-plurality of clusters based on the extracted one or more predefined block features and an intra-cluster variation threshold, and passing the sub-plurality of clusters separately into a plurality of AI models based on the extracted one or more predefined block features.

According to an embodiment of the present disclosure, a method for performing in-loop filtering in a video codec includes obtaining one or more blocks from the video codec at an in-loop filtering stage. The one or more blocks are obtained after a reconstructed frame is constructed. The reconstructed frame is outputted or stored in a reference buffer. Each of the one or more blocks represents a dimension of one or more images in pixels. Further, the method includes extracting one or more predefined block features associated with each of the one or more blocks based on a set of inherent characteristics associated with the one or more blocks, training a plurality of AI models based on the extracted one or more predefined block features, and performing an in-loop filtering on the one or images by using the trained plurality of AI models.

According to an embodiment of the present disclosure, a system for training AI models for in-loop filters includes a memory and one or more processors communicatively coupled to the memory. Further, the one or more processors are configured to generate a training dataset by passing a video through a codec pipeline, extract one or more predefined block features from the training dataset, create a plurality of clusters based on the extracted one or more predefined block features from the training dataset, divide the plurality of clusters into a sub-plurality of clusters based on the extracted one or more predefined block features and an intra-cluster variation threshold, and pass the sub plurality of clusters separately into a plurality of AI models based on the extracted one or more predefined block features.

According to an embodiment of the present disclosure, a system for performing in-loop filtering in a video codec includes a memory and one or more processors communicatively coupled to the memory. Further, the one or more processors are configured to obtain one or more blocks from the video codec at an in-loop filtering stage. The one or more blocks are obtained after a reconstructed frame is constructed. The reconstructed frame is outputted or stored in a reference buffer. Each of the one or more blocks represents a dimension of one or more images in pixels. Furthermore, the one or more processors are configured to extract one or more predefined block features associated with each of the one or more blocks based on a set of inherent characteristics associated with the one or more blocks, train a plurality of AI models based on the extracted one or more predefined block features, and perform an in-loop filtering on the one or images by using the trained plurality of AI models.

To further clarify the advantages and features of the disclosure, a more particular description will be provided by reference to specific example embodiments thereof, which are illustrated in the appended drawings. It is appreciated that these drawings depict only example embodiments and are therefore not to be considered limiting its scope. The example embodiments will be described and explained with additional specificity and detail with the accompanying drawings.

### BRIEF DESCRIPTION OF THE DRAWINGS

The above and/or other aspects of the disclosure will be more apparent by describing certain embodiments of the disclosure with reference to the accompanying drawings, in which:

FIG. 1A is a block diagram depicting a process of performing an in-loop filtering by using codec parameters, as per a conventional technique;

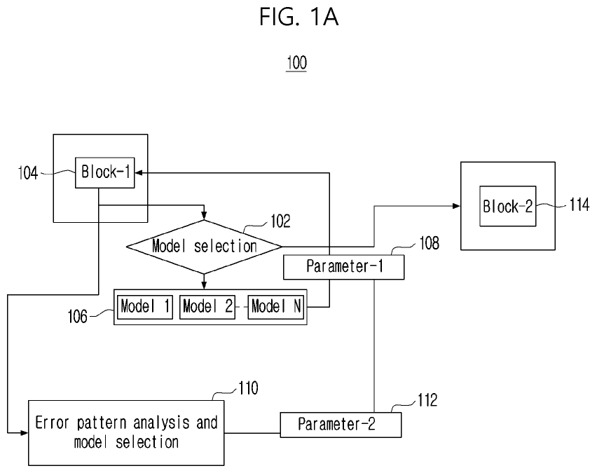

FIG. 1B is a block diagram depicting multiple codec parameter variations, as per a conventional technique;

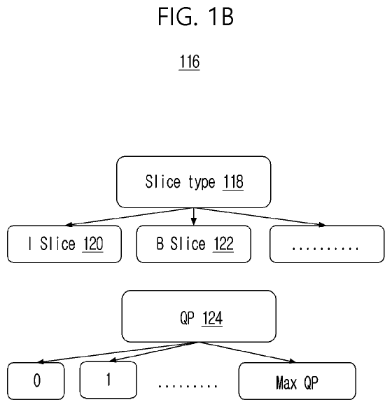

FIG. 2 is a block diagram of an example system for training Artificial Intelligence (AI) models for in-loop filters, according to various embodiments;

FIG. 3 is a block diagram of modules of the example system for training the AI models for in-loop filters, according to various embodiments;

FIG. 4 is a schematic representation depicting training of the AI models for in-loop filters, according to various embodiments;

FIG. 5 is a schematic representation depicting splitting a cluster into a sub-plurality of clusters, according to various embodiments;

FIG. 6 is a block diagram depicting model inferencing during an encoding operation and a decoding operation, according to various embodiments;

FIG. 7 is a block diagram depicting clustering of a training dataset based on one or more predefined block features, according to various embodiments;

FIG. 8 is a flow diagram depicting an example method for training Artificial Intelligence (AI) models for in-loop filters, according to various embodiments; and

FIG. 9 is a flow diagram depicting an example method for performing in-loop filtering in a video codec, according to various embodiments.

Further, skilled artisans will appreciate that elements in the drawings are illustrated for simplicity and may not have necessarily been drawn to scale. For example, the flow charts illustrate certain steps to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those having the benefit of the description herein.

### DETAILED DESCRIPTION

It should be understood at the outset that although illustrative implementations of example embodiments of the present disclosure are illustrated below, the disclosure may be implemented using any number of techniques, whether currently known or in existence. The present disclosure should in no way be limited to the illustrative implementations, drawings, and techniques illustrated below, including the example designs and implementations illustrated and described herein, but may be modified within the scope of the appended claims along with their full scope of equivalents.

The term “some” as used herein may, for example, refer to “none, or one, or more than one, or all.” Accordingly, the terms “none,” “one,” “more than one,” “more than one, but not all” or “all” would all fall under the definition of “some.” The term “some embodiments” may, for example, refer to no embodiments or to one embodiment or to several embodiments or to all embodiments. Accordingly, the term “some embodiments” may, for example, refer to “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to, for example, as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the disclosure will be described below in detail with reference to the accompanying drawings.

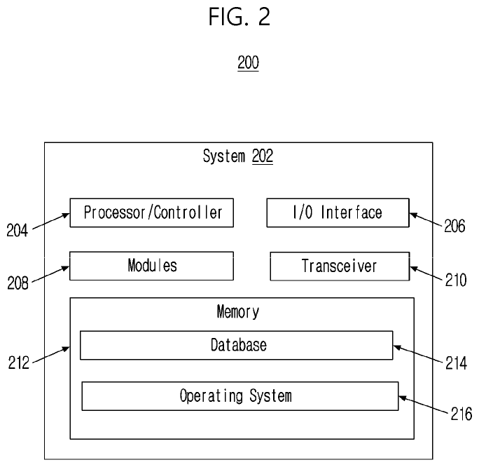

FIG. 2 is a block diagram 200 of an example system 202 for training Artificial Intelligence (AI) models for in-loop filters, according to various embodiments. In an embodiment, the system 202 may be included within a User Equipment (UE). In various embodiments, the system 202 may be configured to operate as a standalone device or a system. By way of example, the user equipment may be a cellular phone, tablet, drone, camera, smart watch, and the like.

In an embodiment of the present disclosure, the system 202 may include one or more processors/controllers 204, an Input/Output (I/O) interface 206, modules 208, a transceiver 210, and a memory 212.

In an example embodiment, the one or more processors/controllers 204 (including, e.g., processing circuitry) may be operatively coupled to each of the respective I/O interface 206, the modules 208, the transceiver 210 and the memory 212. In an embodiment, the one or more processors/controllers 204 may include at least one data processor for executing processes in a Virtual Storage Area Network. The one or more processors/controllers 204 may include specialized processing units such as, integrated system (bus) controllers, memory management control units, floating point units, graphics processing units, digital signal processing units, etc. In an embodiment, the one or more processors/controllers 204 may include a central processing unit (CPU), a graphics processing unit (GPU), or both. The one or more processors/controllers 204 may be one or more general processors, digital signal processors, application-specific integrated circuits, field-programmable gate arrays, servers, networks, digital circuits, analog circuits, combinations thereof, or other now known or later developed devices for analyzing and processing data. The one or more processors/controllers 204 may execute a software program, such as code generated manually (i.e., programmed) to perform a desired operation(s).

The one or more processors/controllers 204 may be disposed in communication with one or more input/output (I/O) devices via the respective I/O interface 206. The I/O interface 206 may employ communication code-division multiple access (CDMA), high-speed packet access (HSPA+), global system for mobile communications (GSM), long-term evolution (LTE), WiMax, or the like, etc.

Using the I/O interface 206, the system 202 may communicate with one or more I/O devices, specifically, user devices associated with human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The one or more processors/controllers 204 may be disposed in communication with a communication network via a network interface. In an embodiment, the network interface may be the I/O interface 206 (including, e.g., interface circuitry). The network interface may connect to the communication network to enable connection of the system 202 with the outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc.

In various embodiments, the memory 212 may be communicatively coupled to the one or more processors/controllers 204. The memory 212 may be configured to store data, instructions executable by the one or more processors/controllers 204. In an embodiment, the memory 212 may communicate via a bus within the system 202. The memory 212 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In an example embodiment, the memory 212 may include a cache or random-access memory for the one or more processors/controllers 204. In various embodiments, the memory 212 may be separate from the one or more processors/controllers 204 such as a cache memory of a processor, the system memory, or other memory. The memory 212 may be an external storage device or database for storing data. The memory 212 may be operable to store instructions executable by the one or more processors/controllers 204. The functions, acts or tasks illustrated in the figures or described herein may be performed by the programmed processor/controller for executing the instructions stored in the memory 212. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In various embodiments, the modules 208 may be included within the memory 212. The memory 212 may further include a database 214 to store data. The modules 208 may include a set of instructions that may be executed to cause the system 202 to perform any one or more of the methods/processes disclosed herein. The modules 208 may be configured to perform the steps of the example embodiments using the data stored in the database 214 to train the AI models for in-loop filters as discussed herein. In an embodiment, each of the modules 208 may be a hardware unit which may be outside the memory 212. Further, the memory 212 may include an operating system 216 for performing one or more tasks of the system 202, as performed by a generic operating system 216 in the communications domain. The transceiver 210 may be configured to receive and/or transmit signals to and from the system 202. In an embodiment, the database 214 may be configured to store the information as required by the modules 208 and the one or more processors/controllers 204 for training the AI models for in-loop filters.

In an embodiment, the I/O interface 206 may enable input and output to and from the system 202 using suitable devices such as, but not limited to, display, keyboard, mouse, touch screen, microphone, speaker and so forth.

Further, the disclosure also contemplates a non-transitory computer-readable medium that includes instructions or receives and executes instructions responsive to a propagated signal. Further, the instructions may be transmitted or received over the network via a communication port or interface or using a bus (not shown). The communication port or interface may be a part of the one or more processors/controllers 204 or may be a separate component. The communication port may be created in software or may be a physical connection in hardware. The communication port may be configured to connect with a network, external media, the display, or any other components in the system 202, or combinations thereof. The connection with the network may be a physical connection, such as a wired Ethernet connection or may be established wirelessly. Likewise, the additional connections with other components of the system 202 may be physical or may be established wirelessly. The network may alternatively be directly connected to the bus. For the sake of brevity, the architecture and standard operations of the operating system 216, the memory 212, the database 214, the one or more processors/controllers 204, the transceiver 210 and the I/O interface 206 are not discussed in detail.

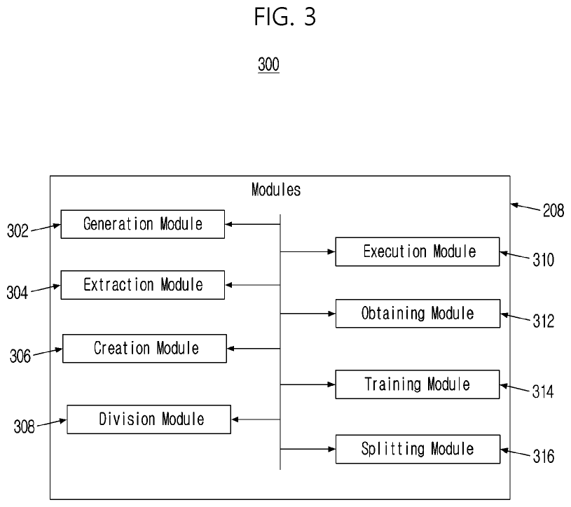

FIG. 3 is a block diagram 300 of example modules 208 of the system 202 for training the AI models for in-loop filters, according to various embodiments. The example embodiment of FIG. 3 also depicts a sequence flow of processes among the modules 208 for performing in-loop filtering in the video codec, which is performed to remove codec artifacts during compression. The modules 208 may include, but are not limited to, a generation module 302, an extraction module 304, a creation module 306, a division module 308, an execution module 310, an obtaining module 312, a training module 314, and a splitting module 316. The modules 208 may be implemented by way of suitable hardware and/or software applications.

In an embodiment of the present disclosure, the generation module 302 is configured to generate a training dataset by passing a video or one or more images through a codec pipeline. The video codec pipeline is hardware, software or a combination thereof that compresses and decompresses a digital video. In an example embodiment of the present disclosure, the codec pipeline is a fixed function hardware video codec responsible for decoding and encoding High Efficiency Video Coding (HEVC) video streams associated with the video. The training dataset corresponds to one or more blocks of fixed sizes associated with the video. In an example embodiment of the present disclosure, each of the one or more blocks represents a dimension of the video in pixels.

Further, the extraction module 304 is configured to extract one or more predefined block features from the training dataset. In an example embodiment of the present disclosure, the one or more predefined block features include an error band, a standard deviation, a mean of the one or more blocks, and the like.

Furthermore, the data creation module 306 is configured to create a plurality of clusters based on the extracted one or more predefined block features from the training dataset. For example, the training dataset is divided to create the plurality of clusters based on the error band. In an embodiment of the present disclosure, the plurality of clusters may be unequal in size.

The division module 308 is configured to divide the plurality of clusters into a sub-plurality of clusters based on the extracted one or more predefined block features and an intra-cluster variation threshold. In an embodiment of the present disclosure, the division module 308 determines if a cluster from the plurality of clusters has a variation within the cluster in comparison to other clusters of the plurality of clusters. The variation is determined based on an intra-cluster sparsity. If the variation is above the intra-cluster variation threshold, the division module 308 splits the cluster into a plurality of sub-clusters.

In an embodiment of the present disclosure, the training module 314 is configured to obtain a set of cluster centroids for the sub-plurality of clusters upon dividing the plurality of clusters. Each of the set of cluster centroids is representation of a segregated cluster of the training dataset. In an embodiment of the present disclosure, the cluster of the training dataset is segregated based on the one or more predefined block features. The training module 314 trains a plurality of AI models for each of the sub-plurality of clusters based on the one or more predefined block features and the obtained set of cluster centroids. In an example embodiment of the present disclosure, the plurality of AI models correspond to deep learning based in-loop filters.

Further, the execution module 310 is configured to pass the sub-plurality of clusters separately into the plurality of AI models based on the extracted one or more predefined block features. In passing the sub-plurality of clusters separately into the plurality of AI models, the execution module 310 identifies a closest cluster centroid with respect to one or more blocks associated with the video based on the extracted one or more predefined block features. In an embodiment of the present disclosure, the closest cluster centroid is a cluster centroid from the set of cluster centroids associated with the sub-plurality of clusters of the training dataset. In an example embodiment of the present disclosure, each of the one or more blocks represents a dimension of the video in pixels. The execution module 310 selects a trained AI model for the identified closest cluster centroid from the trained plurality of AI models based on the extracted one or more predefined block features. Furthermore, the execution module 310 performs the in-loop filtering on the video by applying the selected trained AI model to the identified closest cluster centroid. In an embodiment of the present disclosure, the trained AI model is applied to the identified closest cluster centroid during an encoding operation and a decoding operation of the video.

In identifying the closest cluster centroid, the execution module 310 calculates the distance between each of the one or more blocks and the set of cluster centroids. Further, the execution module 310 identifies the closest cluster centroid for each of the one or more blocks based on the calculated distance and the extracted one or more predefined block features.

In an embodiment of the present disclosure, the system 202 is configured to perform the in-loop filtering in the video codec. In an example embodiment of the present disclosure, base codec is Versatile Video Coding (VVC) i.e., VVC Test model (VTM) 11.0. The system 202 includes the obtaining module 312 configured to obtain the one or more blocks from the video codec at an in-loop filtering stage. In an embodiment of the present disclosure, the one or more blocks are obtained after a reconstructed frame is constructed before an AI based in-loop filtering stage. The reconstructed frame is outputted or stored in a reference buffer. In an embodiment of the present disclosure, the reconstructed frames are received before the in-loop filtering stage of the video codec. Further, each of the one or more blocks represents a dimension of one or more images in pixels. In an embodiment of the present disclosure, the one or more blocks are extracted before in-loop filtering stage.

Further, the extraction module 304 is configured to extract the one or more predefined block features associated with each of the one or more blocks based on a set of inherent characteristics associated with the one or more blocks. In an example embodiment of the present disclosure, the set of inherent characteristics include, for example, mean of error, variance, edge strengths, and the like. In an embodiment of the present disclosure, the set of inherent characteristics are unassociated with a set of codec parameters, such as slice type, quantization parameter, and the like. In an example embodiment of the present disclosure, the one or more predefined block features include an error band, a standard deviation, a mean of the one or more blocks, and the like. In an embodiment of the present disclosure, the one or more predefined block features includes more information associated with the one or more blocks in comparison to the set of codec parameters.

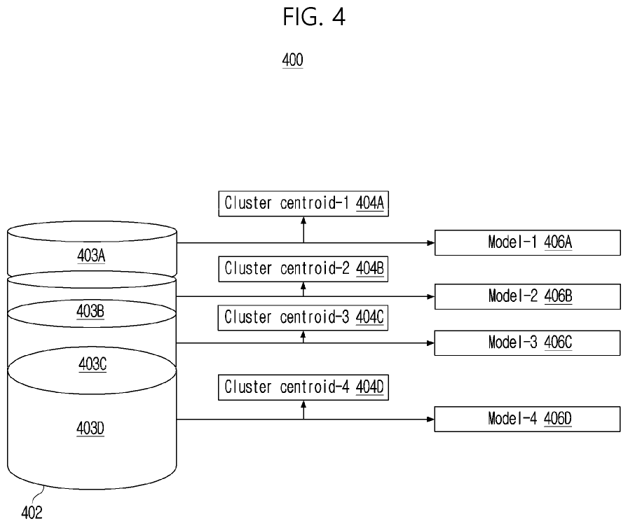

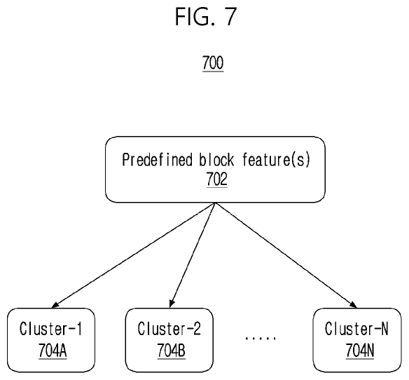

Thereafter, the training module 314 is configured to train a plurality of AI models based on the extracted one or more predefined block features. In training the plurality of AI models based on the extracted one or more predefined block features, the training module 314 generates a training dataset by passing the one or more images through a codec pipeline before the in-loop filtering stage. In an embodiment of the present disclosure, the training dataset corresponds to the one or more blocks of fixed sizes associated with the one or more images. Further, the training module 314 clusters the generated training dataset into a plurality of clusters based on the one or more predefined block features associated with the one or more images. For example, the one or more predefined block features may be the error band, the standard deviation, and the like. Details on clustering the generated training dataset are elaborated in subsequent paragraphs of the present disclosure with reference to FIG. 7. The training module 314 obtains a set of cluster centroids for the plurality of clusters. In an embodiment of the present disclosure, each of the set of cluster centroids is a representation of a segregated cluster of the training dataset. The cluster of the training dataset is segregated based on the one or more predefined block features. Furthermore, the training module 314 trains the plurality of AI models for each of the plurality of clusters based on the one or more predefined block features and the obtained set of cluster centroids. In an embodiment of the present disclosure, the plurality of AI models are trained on specific features of the plurality of clusters. For example, the training of AI models is performed based on quantization error pattern or any other predefined image feature of the one or more blocks, such that AI models may be trained for the one or more blocks with specific predefined block features. In an embodiment of the present disclosure, prominent error bands i.e., error ranges with high probability, are focused on by subdividing these regions to have more models representing them. Details on training the plurality of AI models are elaborated in subsequent paragraphs of the present disclosure with reference to FIG. 4.

Furthermore, the execution module 310 is configured to perform an in-loop filtering on the one or images using the trained plurality of AI models. In performing the in-loop filtering on the one or images using the trained plurality of AI models, the execution module 310 identifies a closest cluster centroid with respect to the one or more blocks based on the extracted one or more predefined block features. In an embodiment of the present disclosure, the closest cluster centroid is a cluster centroid from a set of cluster centroids associated with the plurality of clusters of the training dataset. The execution module 310 selects a trained AI model for the identified closest cluster centroid from the trained plurality of AI models based on the extracted one or more predefined block features. Further, the execution module 310 performs in-loop filtering on the one or more images by applying the selected trained AI model to the identified closest cluster centroid. In an embodiment of the present disclosure, the selected trained AI model is applied to the identified closest cluster centroid during an encoding operation and a decoding operation of the one or more images. In an embodiment of the present disclosure, model inferencing during in-loop filter application using cluster centroids avoids the requirement for signaling any codec parameter in the bit stream to indicate a model index.

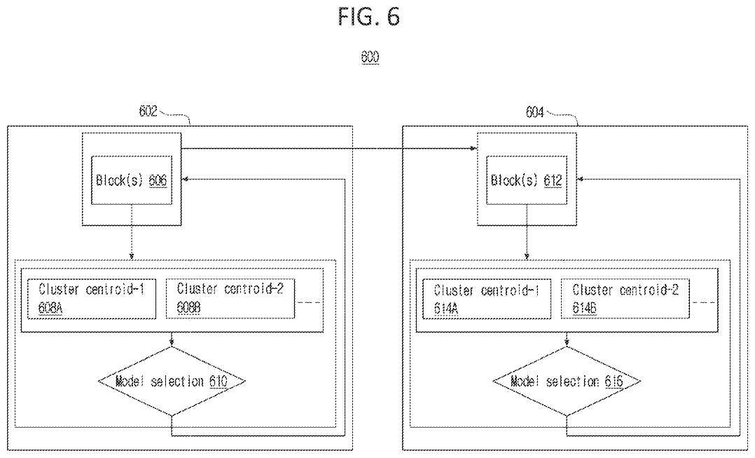

In an embodiment of the present disclosure, the trained AI model is selected from the plurality of AI models based on the extracted one or more predefined block features of the one or more blocks for inferencing during encoding and decoding without the requirement to pass any parameters in a bit stream. Details on selecting the trained AI model and inferencing at an encoder and a decoder are elaborated in subsequent paragraphs of the present disclosure with reference to FIG. 6.

In identifying the closest cluster centroid with respect to the one or more blocks based on the extracted one or more predefined block features, the execution module 310 is configured to calculate a distance between each of the one or more blocks and the set of cluster centroids. Further, the execution module 310 identifies the closest cluster centroid for each of the one or more blocks based on the calculated distance and the extracted one or more predefined block features.

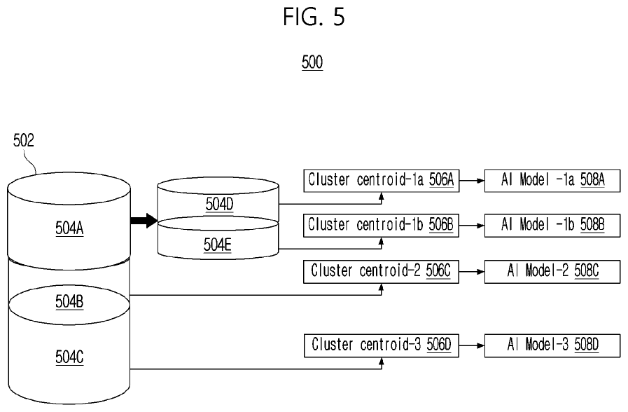

In an embodiment of the present disclosure, the splitting module 316 determines if a cluster from the plurality of clusters have a variation within the cluster in comparison to other clusters of the plurality of clusters. The variation is determined based on an intra-cluster sparsity. Further, the splitting module 316 splits the cluster into a sub-plurality of clusters of upon determining that the plurality of clusters have the variation in comparison to the other clusters. Details on splitting the cluster into the sub-plurality of clusters are elaborated in subsequent paragraphs of the present disclosure with reference to FIG. 5. The splitting of the cluster into the sub-plurality of clusters enables the data associated with the training dataset to be more specific. In an embodiment of the present disclosure, the sub-plurality of clusters are separately passed into the plurality of AI models based on the extracted one or more predefined block features for performing the in-loop filtering on the one or more images.

FIG. 4 is a schematic representation 400 depicting training of a plurality of AI models for in-loop filters, according to various embodiments.

In an embodiment of the present disclosure, the training dataset 402 is divided into the plurality of clusters based on the one or more predefined block features associated with the one or more images. As depicted, the plurality of clusters are cluster-1 403A, cluster-2 403B, cluster-3 403C, and cluster-4 403D. The training dataset 402 is split in patches of fixed sizes for training the plurality of AI models. As depicted, the training dataset is split unequally based on the one or more predefined block features. For example, the one or more predefined block features may be the error band. Further, the set of cluster centroids is obtained for the plurality of clusters. In an embodiment of the present disclosure, each of the set of cluster centroids is a representation of the cluster segregated based on the training dataset 402. As depicted, the set of cluster centroids may be a cluster centroid-1 404A, a cluster centroid-2 404B, a cluster centroid-3 404C, and cluster centroid-4 404D. Furthermore, the plurality of AI models are trained for each of the plurality of clusters based on the one or more predefined block features and the obtained set of cluster centroids. As depicted, the plurality of AI models may be AI model-1 406A, AI model-2 406B, AI model-3 406C, and AI model-4 406D.

FIG. 5 is a schematic representation 500 depicting splitting the cluster into the sub-plurality of clusters, according to various embodiments.

In an embodiment of the present disclosure, the training dataset 502 is divided into the plurality of clusters based on the one or more predefined block features, such as the error band. The training dataset 502 is split unequally based on the error band. As depicted, the plurality of clusters are cluster-1 504A, cluster-2 504B, and cluster-3 504C. Further, it is determined that the cluster-1 504A has more variation in comparison to other clusters of the plurality of clusters based on the intra-cluster sparsity. Furthermore, the cluster-1 504A is split into a cluster-1a 504D and a cluster-1b 504E. In an embodiment of the present disclosure, the set of cluster centroids are obtained for the plurality of clusters and the sub-plurality of clusters. As depicted, the set of cluster centroids may be a cluster centroid-1a 506A, a cluster centroid-1b 506B, a cluster centroid-2 506C, and a cluster centroid-3 506D. Furthermore, the plurality of AI models are trained for each of the plurality of clusters based on the one or more predefined block features and the obtained set of cluster centroids. As depicted, the plurality of AI models may be AI model-1a 508A, AI model-1b 508B, AI model-2 508C, and AI model-3 508D.

FIG. 6 is a block diagram 600 depicting model inferencing during the encoding operation and the decoding operation, according to various embodiments.

In an embodiment of the present disclosure, 602 represents an encoder and 604 represents a decoder. For each of one or more blocks 606 at the encoder 602, a distance between the one or more blocks 606 and the set of cluster centroids is calculated. For example, the set of cluster centroids may be a cluster centroid-1 608A, a cluster centroid-2 608B, and the like. Further, the closest cluster centroid for each of the one or more blocks 606 is identified by the encoder 602 based on the calculated distance. The identified closest cluster centroid is a representative of the one or more blocks 606. Furthermore, at step 610, a trained AI model is selected for the identified closest cluster centroid from the trained plurality of AI models. Further, the in-loop filtering is performed on the one or more blocks at the encoder 602 by applying the selected trained AI model to the identified closest cluster centroid.

In an example embodiment of the present disclosure, current AI model give a result of 6.9% BD Rate gain on class C sequences defined by common test condition of Moving Picture Experts Group (MPEG).

Similarly, for each of one or more blocks 612 at the decoder 604, a distance between the one or more blocks 612 and the set of cluster centroids is calculated. For example, the set of cluster centroids may be a cluster centroid-1 614A, a cluster centroid-2 614B, and the like. Further, the closest cluster centroid for each of the one or more blocks 612 is identified by the decoder 604 based on the calculated distance. Furthermore, at step 616, the trained AI model is selected for the identified closest cluster centroid from the trained plurality of AI models. Further, the in-loop filtering is performed on the one or more blocks at the decoder 604 by applying the selected trained AI model to the identified closest cluster centroid. Thus, the encoder 602 and the decoder 604 do not signal any codec parameter in the bit stream specific to in-loop filtering. Table 2 shows an example scenario related to cost of signalling compared to overall for 1 bit using fixed length coding.

TABLE 2

| | | | Cost of |
|---|---|---|---|
| | | | signalling |
| | | | compared |
| | | | to overall |
| | | | for 1 bit |
| | | Inference | using fixed |
| Model | Inference | block size | length coding |
| With | VVC | 32 × 32 | ~90% |
| signalling | codec | | |
| parameters in | | | |
| bit stream | | | |
| With | VVC | 64 × 64 | ~23% |
| signalling | codec | | |
| parameters in | | | |
| bit stream | | | |

FIG. 7 is a block diagram 700 depicting clustering of a training dataset based on one or more predefined block features, according to various embodiments.

In an embodiment of the present disclosure, the training dataset is divided into the plurality of clusters based on the one or more predefined block features 702 associated with the one or more images, as depicted. For example, the plurality of clusters may be cluster-1 704A, cluster-2 704B, . . . cluster-N 704N. Further, the plurality of AI models are trained for each of the plurality of clusters based on the one or more predefined block features 702 and the set of cluster centroids associated with the plurality of clusters. Table 3 shows an example scenario related to an AI model trained for each of the plurality of clusters.

TABLE 3

| Cluster | Model index |
|---|---|
| 1 | AI Model 1 |
| 2 | AI Model 2 |
| 3 | AI Model 3 |
| . . . | AI Model N |

In conventional approaches, the codec parameters, such as Quantization Parameter (QP), a slice type, and the like, are considered independently and separate AI models are trained on the codec parameters. However, the number of AI models required in the conventional approach is huge. Since block characteristics are a better indication of independent features of the one or more images, the one or more predefined block features are used in the present disclosure to train the AI models, resulting in a lesser number of models.

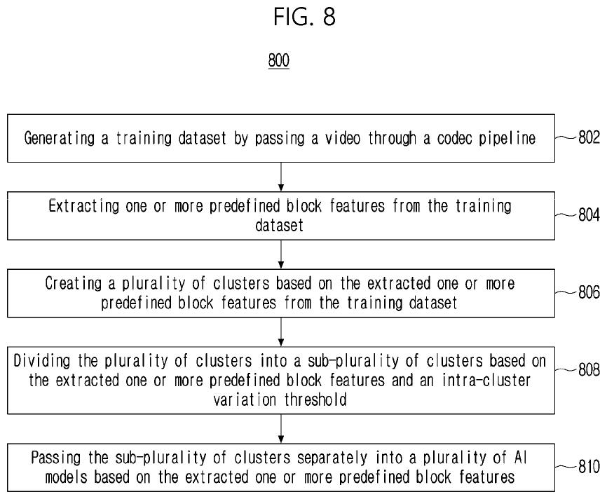

FIG. 8 is a flow diagram depicting an example method for training Artificial Intelligence (AI) models for In-loop filters, according to various embodiments. The method 800 as shown in FIG. 8 is implemented, for example, in a User Equipment (UE). Further, a detailed description of the method 800 is omitted here for the sake of brevity.

At step 802, the method 800 includes generating a training dataset by passing a video or one or more images through a codec pipeline. The video codec pipeline is hardware, software or a combination thereof that compresses and decompresses a digital video. In an example embodiment of the present disclosure, the codec pipeline is a fixed function hardware video codec for decoding and encoding High Efficiency Video Coding (HEVC) video streams associated with the video. The training dataset corresponds to one or more blocks of fixed sizes associated with the video. In an example embodiment of the present disclosure, each of the one or more blocks represents a dimension of the video in pixels.

At step 804, the method 800 includes extracting one or more predefined block features from the training dataset. In an example embodiment of the present disclosure, the one or more predefined block features include an error band, a standard deviation, a mean of the one or more blocks, and the like.

At step 806, the method 800 includes creating a plurality of clusters based on the extracted one or more predefined block features from the training dataset. Details on creating the plurality of clusters of the generated training dataset have been elaborated in previous paragraphs of the present disclosure with reference to FIG. 7. For example, the training dataset is divided to create a plurality of clusters based on the error band. In an embodiment of the present disclosure, the plurality of clusters may be unequal in size.

At step 808, the method 800 includes dividing the plurality of clusters into a sub-plurality of clusters based on the extracted one or more predefined block features and an intra-cluster variation threshold. Details on dividing the cluster into the sub-plurality of clusters have been elaborated in previous paragraphs of the present disclosure with reference to FIG. 5. In an embodiment of the present disclosure, the method 800 includes determining if a cluster from the plurality of clusters have a variation within the cluster in comparison to other clusters of the plurality of clusters. The variation is determined based on an intra-cluster sparsity. If the variation is above the intra-cluster variation threshold, the method 800 includes splitting the cluster into the plurality of sub-clusters.

In an embodiment of the present disclosure, the method 800 includes obtaining a set of cluster centroids for the sub-plurality of clusters upon dividing the plurality of clusters. Each of the set of cluster centroids is a representation of a segregated cluster of the training dataset. In an embodiment of the present disclosure, the cluster of the training dataset is segregated based on the one or more predefined block features. The method 800 includes training a plurality of AI models for each of the sub-plurality of clusters based on the one or more predefined block features and the obtained set of cluster centroids. Details on training the plurality of AI models have been elaborated in previous paragraphs of the present disclosure with reference to FIG. 4. In an example embodiment of the present disclosure, the plurality of AI models correspond to deep learning based in-loop filters.

Further, at step 810, the method 800 includes passing the sub-plurality of clusters separately into the plurality of AI models based on the extracted one or more predefined block features. In passing the sub-plurality of clusters separately into the plurality of AI models, the method 800 includes identifying a closest cluster centroid with respect to one or more blocks associated with the video based on the extracted one or more predefined block features. In an embodiment of the present disclosure, the closest cluster centroid is a cluster centroid from the set of cluster centroids associated with the sub-plurality of clusters of the training dataset. In an example embodiment of the present disclosure, each of the one or more blocks represents a dimension of the video in pixels. The method 800 includes selecting a trained AI model for the identified closest cluster centroid from the trained plurality of AI models based on the extracted one or more predefined block features. Details on selecting the trained AI model have been elaborated in previous paragraphs of the present disclosure with reference to FIG. 6. Furthermore, the method 800 includes performing the in-loop filtering on the video by applying the selected trained AI model to the identified closest cluster centroid. In an embodiment of the present disclosure, the trained AI model is applied to the identified closest cluster centroid during an encoding operation and a decoding operation of the video.

In identifying the closest cluster centroid, the method 800 includes calculating the distance between each of the one or more blocks and the set of cluster centroids. Further, the method 800 includes identifying the closest cluster centroid for each of the one or more blocks based on the calculated distance and the extracted one or more predefined block features.

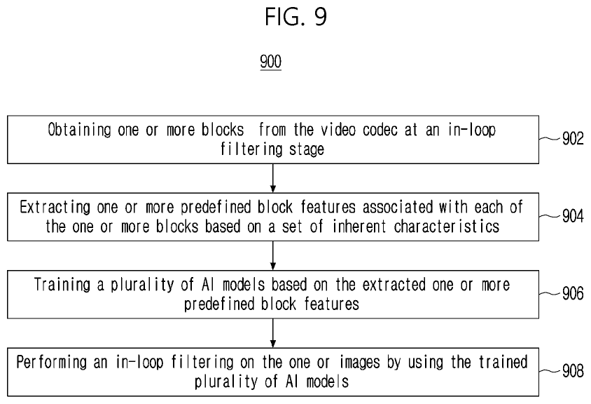

FIG. 9 is a flow diagram depicting an example method for performing the in-loop filtering in the video codec, according to various embodiments. The method 900 as shown in FIG. 9 is implemented, for example, in a UE for performing the in-loop filtering. Further, a detailed description of the method 900 is omitted here for the sake of brevity.

At step 902, the method 900 includes obtaining one or more blocks from the video codec at an in-loop filtering stage. In an embodiment of the present disclosure, the one or more blocks are obtained after a reconstructed frame is constructed. The reconstructed frame is outputted or stored in a reference buffer. In an embodiment of the present disclosure, the reconstructed frames are received before the in-loop filtering stage of the video codec. Further, each of the one or more blocks represents a dimension of one or more images in pixels. In an embodiment of the present disclosure, the one or more blocks are extracted before in-loop filtering stage.

After the step 902, at step 904, the method 900 includes extracting the one or more predefined block features associated with each of the one or more blocks based on a set of inherent characteristics associated with the one or more blocks. In an example embodiment of the present disclosure, the set of inherent characteristics include mean of error, variance, edge strengths, and the like. In an embodiment of the present disclosure, the set of inherent characteristics are unassociated with a set of codec parameters, such as slice type, quantization parameter, and the like. In an example embodiment of the present disclosure, the one or more predefined block features include an error band, a standard deviation, a mean of the one or more blocks, and the like. In an embodiment of the present disclosure, the one or more predefined block features includes more information associated with the one or more blocks in comparison to the set of codec parameters.

At step 906, the method 900 includes training a plurality of AI models based on the extracted one or more predefined block features. In training the plurality of AI models based on the extracted one or more predefined block features, the method 900 includes generating a training dataset by passing the one or more images through a codec pipeline before the in-loop filtering stage. In an embodiment of the present disclosure, the training dataset corresponds to the one or more blocks of fixed sizes associated with the one or more images. Further, the method 900 includes clustering the generated training dataset into a plurality of clusters based on the one or more predefined block features associated with the one or more images. For example, the one or more predefined block features may be the error band, the standard deviation, and the like. Details on clustering the generated training dataset have been elaborated in previous paragraphs of the present disclosure with reference to FIG. 7. The method 900 includes obtaining a set of cluster centroids for the plurality of clusters. In an embodiment of the present disclosure, each of the set of cluster centroids is representation of a segregated cluster of the training dataset. The cluster of the training dataset is segregated based on the one or more predefined block features. Furthermore, the method 900 includes training the plurality of AI models for each of the plurality of clusters based on the one or more predefined block features and the obtained set of cluster centroids. In an embodiment of the present disclosure, the plurality of AI models are trained on specific features of the plurality of clusters. For example, the training of AI models is performed based on quantization error pattern or any other predefined image feature of the one or more blocks, such that AI models may be trained for the one or more blocks with specific predefined block features. In an embodiment of the present disclosure, prominent error bands i.e., error ranges with high probability, are focused on by subdividing those regions to have more models representing them. Details on training the plurality of AI models have been elaborated in previous paragraphs of the present disclosure with reference to FIG. 4.

At step 908, the method 900 includes performing an in-loop filtering on the one or images using the trained plurality of AI models. In performing the in-loop filtering on the one or images by using the trained plurality of AI models, the method 900 includes identifying a closest cluster centroid with respect to the one or more blocks based on the extracted one or more predefined block features. In an embodiment of the present disclosure, the closest cluster centroid is a cluster centroid from a set of cluster centroids associated with the plurality of clusters of the training dataset. The method 900 includes selecting a trained AI model for the identified closest cluster centroid from the trained plurality of AI models based on the extracted one or more predefined block features. Further, the method 900 includes performing in-loop filtering on the one or more images by applying the selected trained AI model for the identified closest cluster centroid. In an embodiment of the present disclosure, the selected trained AI model is applied for the identified closest cluster centroid during an encoding operation and a decoding operation of the one or more images. In an embodiment of the present disclosure, model inferencing during in-loop filter application using cluster centroids avoids the requirement for signaling any codec parameter in the bit stream to indicate a model index. Further, an inferred cluster is passed back to the reconstruction buffer.

In an embodiment of the present disclosure, the trained AI model is selected from the plurality of AI models based on the extracted one or more predefined block features of the one or more blocks for inferencing during encoding and decoding without the requirement to pass any parameters in a bit stream. Details on selecting the trained AI model and inferencing at an encoder and a decoder have been elaborated in previous paragraphs of the present disclosure with reference to FIG. 6.

In identifying the closest cluster centroid with respect to the one or more blocks based on the extracted one or more predefined block features, the method 900 includes calculating a distance between each of the one or more blocks and the set of cluster centroids. Further, the method 900 includes identifying the closest cluster centroid for each of the one or more blocks based on the calculated distance and the extracted one or more predefined block features.

In an embodiment of the present disclosure, the method 900 includes determining if a cluster from the plurality of clusters has a variation within the cluster in comparison to other clusters of the plurality of clusters. The variation is determined based on an intra-cluster sparsity. Further, the method 900 includes splitting the cluster into a sub-plurality of clusters upon determining that the plurality of clusters have the variation in comparison to the other clusters. Details on splitting the cluster into the sub-plurality of clusters have been elaborated in previous paragraphs of the present disclosure with reference to FIG. 5. The splitting of the cluster into the sub-plurality of clusters enables the data associated with the training dataset to be more specific. In an embodiment of the present disclosure, the sub-plurality of clusters are separately passed into the plurality of AI models based on the extracted one or more predefined block features for performing the in-loop filtering on the one or more images.

The systems and methods of the example embodiments provide advantages including, but not limited to, the following advantages.

The present disclosure provides a predefined block feature aware model selection technique for inferencing during encoding and decoding without any requirement to pass any codec parameter in bit stream.

The present disclosure provides model training based on the one or more predefined block features of the one or more blocks wherein specific models may be trained for blocks with specific features. Further, the present disclosure divides the clusters with higher variation into sub-clusters, creating a hierarchical clustering.

The present disclosure uses a same model for all slice types i.e., intra, inter, and the like or QPs as the models depend on inherent features of the block rather than codec parameters. This reduces the requirement of the number of models.

The present disclosure proposes to use quantization error pattern from encoder and use it at the decoder to further improve the decoded quality of the videos.

The present disclosure can avoid or reduce having multiple models for combination of codec parameters resulting in a codec parameter agnostic approach.

The present invention disclosure provides efficient selection of an in-loop filter based on both, the QP as well as quantization error of a particular video block.

The present disclosure relates to enhancement of decoded videos and removal of encoding artifacts based on efficiencies in loop filter selection and training.

Conventional solutions use the QP as a basis for training the models which may not capture all the variations of encoding errors. The present disclosure uses a quantization error band as a basis for training the model to capture the specific variations.

The present disclosure selects a quantization error band-based method at each block to better capture the error of that block.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to example embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been illustrated and described with reference to various example embodiments, it will be understood that the various example embodiments are intended to be illustrative, not limiting. It will be further understood by those of ordinary skill in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for training Artificial Intelligence (AI) models for In-loop filters, the method comprising:
generating, by one or more processors, a training dataset by passing a video through a codec pipeline;
extracting, by the one or more processors, one or more predefined block features from the training dataset;
creating, by the one or more processors, a plurality of clusters based on the extracted one or more predefined block features from the training dataset;
dividing, by the one or more processors, the plurality of clusters into a sub-plurality of clusters based on the extracted one or more predefined block features and an intra-cluster variation threshold; and
supplying, by the one or more processors, the sub-plurality of clusters separately into a plurality of AI models based on the extracted one or more predefined block features.

2. The method as claimed in claim 1, further comprising:
obtaining a set of cluster centroids for the sub-plurality of clusters upon dividing the plurality of clusters, wherein each of the set of cluster centroids is representation of a segregated cluster of the training dataset, and wherein the cluster of the training dataset is segregated based on the one or more predefined block features; and
training the plurality of AI models for each of the sub-plurality of clusters based on the one or more predefined block features and the obtained set of cluster centroids.

3. The method as claimed in claim 2, wherein supplying the sub-plurality of clusters separately into the plurality of AI models comprises:
identifying a closest cluster centroid with respect to one or more blocks associated with the video based on the extracted one or more predefined block features, wherein the closest cluster centroid is a cluster centroid from the set of cluster centroids associated with the sub-plurality of clusters of the training dataset, and wherein each of the one or more blocks represents a dimension of the video in pixels;
selecting a trained AI model for the identified closest cluster centroid from the trained plurality of AI models based on the extracted one or more predefined block features; and
performing in-loop filtering on the video by applying the selected trained AI model to the identified closest cluster centroid.

4. The method as claimed in claim 3, wherein identifying the closest cluster centroid comprises:
calculating a distance between each of the one or more blocks and the set of cluster centroids; and
identifying the closest cluster centroid for each of the one or more blocks based on the calculated distance and the extracted one or more predefined block features.

5. The method as claimed in claim 3, wherein the trained AI model is applied to identified closest cluster centroid during an encoding operation and a decoding operation of the video.

6. A method for performing in-loop filtering in a video codec, the method comprising:
obtaining, by one or more processors, one or more blocks from the video codec at an in-loop filtering stage, wherein the one or more blocks are obtained after a reconstructed frame is constructed, and wherein the reconstructed frame is one of outputted and stored in a reference buffer, and wherein each of the one or more blocks represents a dimension of one or more images in pixels;
extracting, by the one or more processors, one or more predefined block features associated with each of the one or more blocks based on a set of inherent characteristics associated with the one or more blocks;
training, by the one or more processors, a plurality of Artificial Intelligence (AI) models based on the extracted one or more predefined block features; and
performing, by the one or more processors, an in-loop filtering on the one or images using the trained plurality of AI models.

7. The method as claimed in claim 6, wherein performing the in-loop filtering on the one or more images using the trained plurality of AI models comprises:
identifying, by the one or more processors, a closest cluster centroid with respect to the one or more blocks based on the extracted one or more predefined block features, wherein the closest cluster centroid is a cluster centroid from a set of cluster centroids associated with a plurality of clusters of a training dataset;
selecting, by the one or more processors, a trained AI model for the identified closest cluster centroid from the trained plurality of AI models based on the extracted one or more predefined block features; and
performing, by the one or more processors, the in-loop filtering on the one or more images by applying the selected trained AI model to the identified closest cluster centroid.

8. The method as claimed in claim 7, wherein training the plurality of AI models based on the extracted one or more predefined block features comprises:
generating a training dataset by passing the one or more images through a codec pipeline before the in-loop filtering stage, wherein the training dataset corresponds to the one or more blocks of fixed sizes associated with the one or more images;
clustering the generated training dataset into a plurality of clusters based on the one or more predefined block features associated with the one or more images;
obtaining a set of cluster centroids for the plurality of clusters, wherein each of the set of cluster centroids is representation of a segregated cluster of the training dataset, and wherein the cluster of the training dataset is segregated based on the one or more predefined block features; and
training the plurality of AI models for each of the plurality of clusters based on the one or more predefined block features and the obtained set of cluster centroids.

9. The method as claimed in claim 7, wherein identifying the closest cluster centroid with respect to the one or more blocks based on the extracted one or more predefined block features comprises:
calculating a distance between each of the one or more blocks and the set of cluster centroids; and
identifying the closest cluster centroid for each of the one or more blocks based on the calculated distance and the extracted one or more predefined block features.

10. The method as claimed in claim 7, wherein the trained AI model is applied to the identified closest cluster centroid during an encoding operation and a decoding operation of the one or more images.

11. The method as claimed in claim 8, further comprising:
determining if a cluster from the plurality of clusters has a variation within the cluster in comparison to other clusters of the plurality of clusters, wherein the variation is determined based on an intra-cluster sparsity; and
splitting the cluster into a sub-plurality of clusters upon determining that the cluster from the plurality of clusters has the variation in comparison to the other clusters.

12. A system for training Artificial Intelligence (AI) models for In-loop filters, the system comprising:
a memory; and
one or more processors communicatively coupled to the memory, wherein the memory comprises a plurality of modules in the form of programmable instructions executable by the one or more processors, and wherein the plurality of modules comprises:
a generation module configured to generate a training dataset by passing a video through a codec pipeline;
an extraction module configured to extract one or more predefined block features from the training dataset;
a creation module configured to create a plurality of clusters based on the extracted one or more predefined block features from the training dataset;
a division module configured to divide the plurality of clusters into a sub-plurality of clusters based on the extracted one or more predefined block features and an intra-cluster variation threshold; and
an execution module configured to supply the sub-plurality of clusters separately into a plurality of AI models based on the extracted one or more predefined block features.

13. The system as claimed in claim 12, further comprising a training module configured to:
obtain a set of cluster centroids for the sub-plurality of clusters upon dividing the plurality of clusters, wherein each of the set of cluster centroids is a representation of a segregated cluster of the training dataset, and wherein the cluster of the training dataset is segregated based on the one or more predefined block features; and
train the plurality of AI models for each of the sub-plurality of clusters based on the one or more predefined block features and the obtained set of cluster centroids.

14. The system as claimed in claim 13, wherein, in supplying the sub-plurality of clusters separately into the plurality of AI models, the execution module is configured to:
identify a closest cluster centroid with respect to one or more blocks associated with the video based on the extracted one or more predefined block features, wherein the closest cluster centroid is a cluster centroid from the set of cluster centroids associated with the sub-plurality of clusters of the training dataset, and wherein each of the one or more blocks represents a dimension of the video in pixels;
select a trained AI model for the identified closest cluster centroid from the trained plurality of AI models based on the extracted one or more predefined block features; and
perform in-loop filtering on the video by applying the selected trained AI model to the identified closest cluster centroid.

15. A system for performing in-loop filtering in a video codec, the system comprising:
a memory; and
one or more processors communicatively coupled to the memory, wherein the memory comprises a plurality of modules in the form of programmable instructions executable by the one or more processors, and wherein the plurality of modules comprises:
an obtaining module configured to obtain one or more blocks from the video codec at an in-loop filtering stage, wherein the one or more blocks are obtained after a reconstructed frame is constructed, and wherein the reconstructed frame is one of outputted and stored in a reference buffer, and wherein each of the one or more blocks represents a dimension of one or more images in pixels;
an extraction module configured to extract one or more predefined block features associated with each of the one or more blocks based on a set of inherent characteristics associated with the one or more blocks;
a training module configured to train a plurality of Artificial Intelligence (AI) models based on the extracted one or more predefined block features; and
an execution module configured to perform an in-loop filtering on the one or images using the trained plurality of AI models.
